(19) United States
(12) Patent Application Publication
(10) Pub. No.: US 2020/0103859 A1
(43) Pub. Date: Apr. 2, 2020

(54) PRODUCTION LINE AUTOMATICALLY ALLOCATING DEVICE AND METHOD THEREOF

(71) Applicant: Institute For Information Industry, Taipei (TW)

(72) Inventors: Yen-I OUYANG, Kaohsiung City (TW); Shih-Ying CHEN, Taichung City (TW); Hung-Ming CHEN, Taichung City (TW)

(21) Appl. No.: 16/186,581

(22) Filed: Nov. 11, 2018

(30) Foreign Application Priority Data
Sep. 27, 2018 (TW) 107134113

(51) Int. Cl. G05B 19/418; G06Q 10/06

(52) U.S. Cl. CPC G05B 19/4183; G06Q 10/06316; G06Q 50/04; G05B 19/4187; G06Q 10/06313

(57) ABSTRACT

A production line automatically allocating device includes a processor and a storage, wherein the processor is electrically connected to the storage. The storage stores a plurality of first fabrication process data, a plurality of machine function data and a plurality of machine status feedback data. The processor establishes a plurality of machine function group data according to the plurality of machine function data, determines first production line allocation data according to the plurality of machine function group data and the plurality of first fabrication process data, and updates the first production line allocation data according to the plurality of machine status feedback data in real time.

### PRIORITY

This application claims priority to Taiwan Patent Application No. 107134113 filed on Sep. 27, 2018, which is hereby incorporated by reference in its entirety.

### FIELD

The present invention relates to a production line automatically allocating device and a production line automatically allocating method which is adapted for a production line automatically allocating device. More specifically, the production line automatically allocating device of the present invention determines production line allocation data according to products and machines on the production lines, and dynamically adjusts the production line allocation data according to feedback messages of the machines.

### BACKGROUND

The development of manufacturing products in manufacturing industry is heading toward customization, small quantity and a wide diversity. Each of the products has different fabrication process, and needs different machines and materials. However, the number of machines on production lines is limited, and there are usually many emergencies (e.g. machine malfunction, waiting for materials, urgent orders, mixing order) at the scene of production line. Therefore, there are needs to closely monitor schedules of production lines and duly adjust the machine allocation of production lines.

At present, however, factories often rely on manpower to track production line schedule and coordinate available machines. This way makes the production line information not clear enough, leaves part of machines idled and delays the production line schedules.

Besides, when the aforesaid emergencies occur, the adjustment to production line schedule management is based on the employees' experience. The reliability is unstable and results in low producing efficiency.

Accordingly, a common effort shall be made in the art to provide a production line automatically allocating device and a production line automatically allocating method, which duly make relevant adjustments according to the conditions of each of machines and products, increase utilization rates of machines and decrease waiting time of products in order to reach the best benefit.

### SUMMARY

In order to solve the aforesaid problems, provided is a production line automatically allocating device and a production line automatically allocating method.

The production line automatically allocating device can comprise a processor and a storage, wherein the processor electrically connects to the storage. The storage is configured to store a plurality of first fabrication process data, a plurality of machine function data and a plurality of machine status feedback data. The processor is configured to establish a plurality of machine function group data according to the plurality of machine function data, determine first production line allocation data according to the plurality of machine function group data and the plurality of first fabrication process data, and update the first production line allocation data according to the plurality of machine status feedback data in real time.

The production line automatically allocating method can be adapted for a production line automatically allocating device. The production line automatically allocating method can comprise: storing a plurality of first fabrication process data, a plurality of machine function data and a plurality of machine status feedback data, establishing a plurality of machine function group data according to the plurality of machine function data, determining first production line allocation data according to the plurality of machine function group data and the plurality of first fabrication process data, and updating the first production line allocation data according to the plurality of machine status feedback data in real time.

The detailed technology and preferred embodiments implemented of the present invention are described in the following paragraphs accompanying the appended drawings for people skilled in this field to well appreciate the features of the claimed invention.

### BRIEF DESCRIPTION OF THE DRAWINGS

FIG. 1A is a structural schematic view of a production line automatically allocating device of the first embodiment;

FIG. 1B is a schematic view of a plurality of first fabrication process data of the first embodiment;

FIG. 1C is a schematic view of a first production line allocation data of the first embodiment;

FIG. 2 is a structure schematic view of a production line automatically allocating device of the second embodiment;

FIG. 3A is a schematic view of production line allocation data of the third embodiment;

FIG. 3B is a schematic view of production line allocation data of the third embodiment;

FIG. 3C is a schematic view of production line allocation data of the third embodiment;

FIG. 4A is a schematic view of production line allocation data of the fourth embodiment;

FIG. 4B is a schematic view of production line allocation data of the fourth embodiment;

FIG. 5 is a flowchart diagram of a production line automatically allocating method of the fifth embodiment;

FIG. 6 is a schematic view of a production line automatically allocating method of the sixth embodiment;

FIG. 7 is a schematic view of a production line automatically allocating method of the seventh embodiment;

FIG. 8 is a schematic view of a production line automatically allocating method of the eighth embodiment;

FIG. 9 is a schematic view of a production line automatically allocating method of the ninth embodiment; and

FIG. 10 is a schematic view of a production line automatically allocating method of the tenth embodiment.

### DETAILED DESCRIPTION

In the following description, the present invention will be explained with reference to certain example embodiments thereof. However, these example embodiments are not intended to limit the present invention to any specific example, embodiment, environment, applications or particular implementations described in these example embodiments. Therefore, description of these example embodiments is only for purpose of illustration rather than to limit the present invention, and the scope of this application shall be governed by the claims.

It should be appreciated that, in the following embodiments and the attached drawings, elements unrelated to the present invention are omitted from depiction; and dimensional relationships among individual elements in the attached drawings are provided only for ease of understanding, but not to limit the actual scale. Furthermore, terms “first” and “second” used in the present specification are used to distinguish the order relation between objects rather than to limit the present invention.

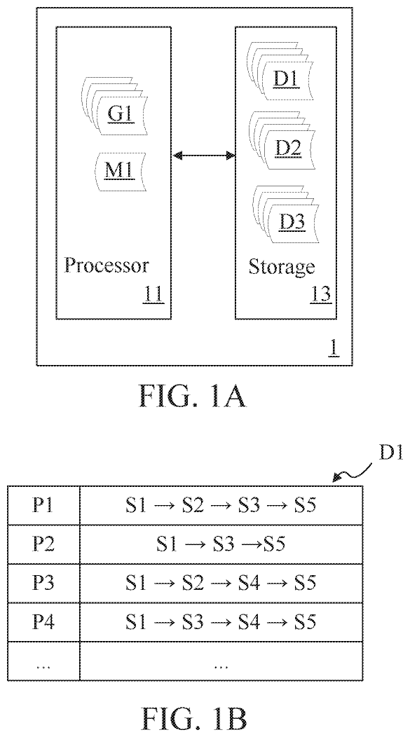

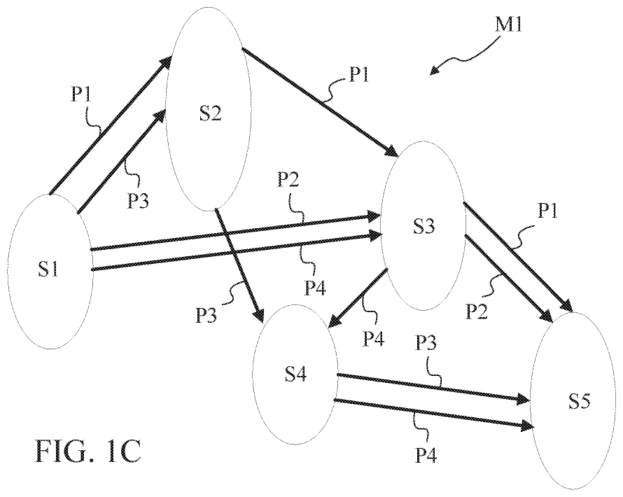

Please refer to FIGS. 1A, 1B and 1C for the first embodiment of the present invention. FIG. 1A is structure schematic view of a production line automatically allocating device 1. FIG. 1B is schematic view of a plurality of first fabrication process data D1 stored by the production line automatically allocating device 1. FIG. 1C is schematic view of first production line allocation data M1 determined by the production line automatically allocating device 1. The following will describe how the production line automatically allocating device 1 determines the first production line allocation data M1.

First, please refer to FIG. 1A. The production line automatically allocating device 1 comprises a processor 11 and a storage 13, wherein both of them electrically connect to each other. The processor 11 may be any kind of processing units, Central Processing Units (CPU), microprocessors or a combination of any kind of computing circuits. The storage 13 may be a memory, a Universal Serial Bus (USB) disk, a hard disk, a compact disk (CD), a flash driver or other media and circuit capable of storing.

Specifically, the storage 13 stores a plurality of first fabrication process data D1, a plurality of machine function data D2 and a plurality of machine status feedback data D3, wherein the plurality of machine function data D2 relate to the machine information of all machines on the production lines. More specifically, the plurality of machine function data D2 record all the machine information on the production lines and the functions which can be performed by each of machines. It shall be noted that some of production line machines only perform one machine function, some of production line machines perform multiple machine functions, and each of machines on the production lines is set with sensors to detect the processing of the machine functions in order to transmit the plurality of machine status feedback data D3. The plurality of machine status feedback data D3 may comprise machine utilization status information, processing progress information, schedule information, completion information, malfunction information, etc., but not to limit the aforesaid content.

Next, please refer to FIG. 1B, which depicts a schematic view of a plurality of product fabrication process information which is recorded in the plurality of first fabrication process data D1. More specifically, the plurality of first fabrication process data D1 record production line machines or some functions of production line machines which have to be used when products are fabricated. For example, the plurality of first fabrication process data D1 records a plurality of fabrication process data of product P1, P2, P3 and P4. As for product P1, it needs to be processed with machine functions S1, S2, S3 and S5 on the production lines. As for product P2, it needs to be processed with machine functions S1, S3 and S5 on the production lines. As for product P3, it needs to be processed with machine functions S1, S2, S4 and S5 on the production line. As for product P4, it needs to be processed with machine functions S1, S3, S4 and S5 on the production line.

Then, please refer to FIG. 1C together, processor 11 establishes a plurality of machine function group data G1 according to the plurality of machine function data D2. Specifically, processor 11 groups all machines on production lines into the plurality of machine function group data G1 according to machine functions. In the first embodiment, the plurality of machine function group data G1 comprises five types of machine functions S1, S2, S3, S4 and S5. Afterwards, the processor 11 determines first production line allocation data M1 according to the plurality of machine function group data G1 and the plurality of first fabrication process data D1.

Next, each of machine function is capable of transmitting a plurality of machine status feedback data D3 to the storage 13, and the processor 11 continuously and dynamically updates the first production line allocation data M1 according to the plurality of machine status feedback data D3. Specifically, for each product path, the processor 11 can utilize the plurality of machine status feedback data D3 to adjust the machine resource allocation of the production line in real time, provide product schedule information, and process completion information, etc., in order to perform adjustment in response to emergencies on production lines.

It shall be noted that, in the first embodiment, the first production line allocation data M1 utilizes topology method to present the fabrication process of products P1, P2, P3 and P4. However, people skilled in this field understand how to change the topology method into other presenting method (e.g. status table) based on the aforesaid disclosures. In addition, the production line automatically allocating device 1 can store the plurality of machine function group data G1 and the first production line allocation data M1 into the storage 11 for later inspection, comparison, utilization, etc.

Moreover, in one embodiment, the storage is further configured to store an optimization function, and the processor is further configured to determine the first production line allocation data M1 according to the optimization function, the plurality of machine function group data G1 and the plurality of first fabrication process data D1. More specifically, the plurality of machine function group data G1 and the plurality of first fabrication process data D1 may comprise relevant weights such that the production line automatically allocating device 1 can utilize each of the weights and the optimization function to determine the first production line allocation data M1. It shall be noted that the optimization function is a profit function, a cost function, a time function, etc. which is based on operation-related factors (e.g. the total amount of order, priority of products, priority of client, idling time of machine, processing speed of machine, processing quality of machine, stock of materials, date of delivery, current condition of production line). People skilled in this field can understand optimization functions and accordingly design the optimization functions, and then select the proper function for the real demands.

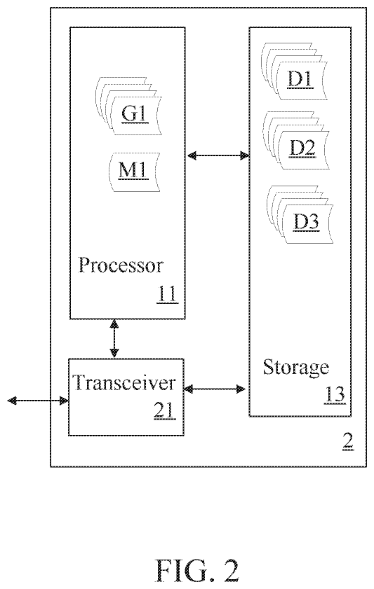

Please refer to FIG. 2 for the second embodiment of the present invention. The production line automatically allocating device 2 of the second embodiment has the similar elements and functions which are comprised by the production line automatically allocating device 1 of the first embodiment, and can generate the first production line allocation data M1 in the similar way. Therefore, similar description is omitted and the following merely focuses on describing the differences therebetween.

Specifically, in comparison with the production line automatically allocating device 1 of the first embodiment, the production line automatically allocating device 2 of the second embodiment further comprises a transceiver 21 in addition to the processor 11 and the storage 13, wherein the transceiver 21 is electrically connected to the processor 11. The transceiver 21 may be connected to production line machines and sensors via cable network or wireless network in order to receive data. The second embodiment comprises multiple implementations, and each of implementations can exist alone or exist together. The details are described in the following.

In one implementation of the second embodiment, the transceiver 21 is electrically connected to the storage 13. The processor 11 is configured to receive the plurality of first fabrication process data D1, the plurality of machine function data D2 and the plurality of machine status feedback data D3 via the transceiver 21, and then store them in the storage 13. In other words, the production line automatically allocating device 2 receives the aforesaid data from each of machines and management devices on production lines via the cable network or wireless network, and stores the aforesaid data into the storage 13. In addition, in one implementation, the production line automatically allocating device 2 also can update the stored data according to the received data.

In one implementation of the second embodiment, the processor 11 generates a plurality of control commands according to the first production line allocation data M1, and then sends them to the plurality of fabrication process machines (not shown) via transceiver 21. In other words, when the production line automatically allocating device 2 dynamically updates the first production line allocation data M1, the production line automatically allocating device 2 also transmits the relevant control commands to the corresponding fabrication process machines on the production lines in order to handle emergencies on the production lines.

In one implementation of the second embodiment, the transceiver 21 receives a plurality of updated machine status feedback data, and use them to update the plurality of machine status feedback data D3 stored in the storage 13. Specifically, the production line automatically allocating device 2 continuously receives updated machine status feedback data from each of fabrication process machines on production lines and then updates the machine status feedback data which is stored in the storage such that the production line automatically allocating device 2 determines the production line allocation data according to the latest information and data.

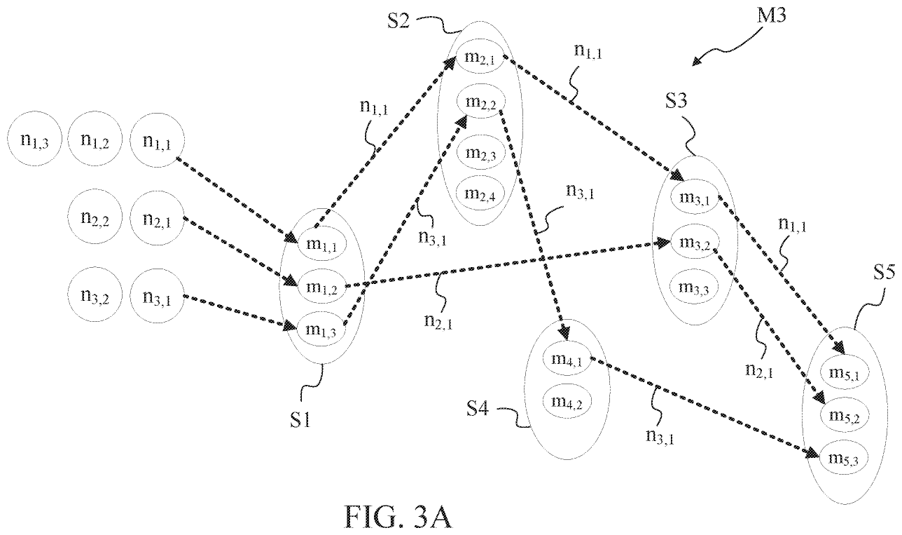

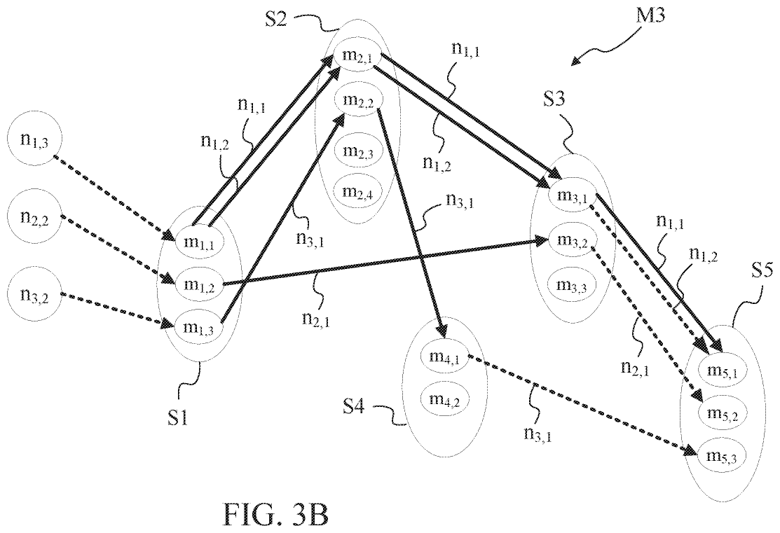

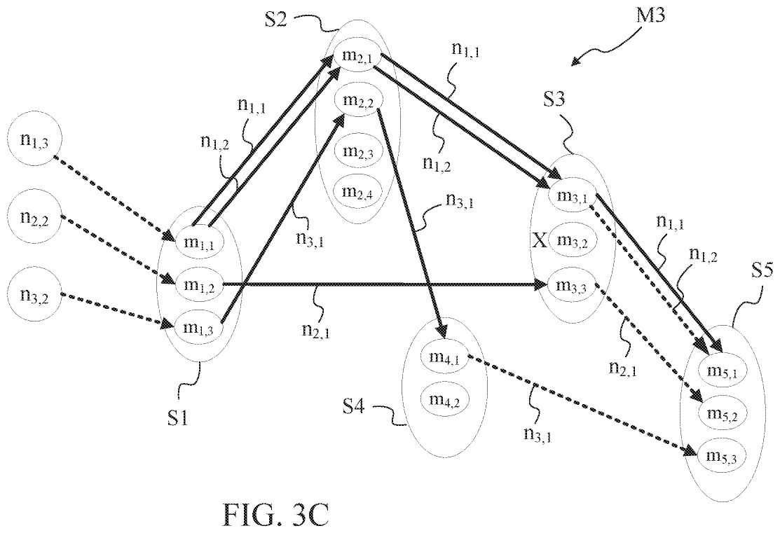

Please refer to FIGS. 3A, 3B and 3C for the third embodiment of the present invention, which is a more specific embodiment. Specifically, the third embodiment is based on an actual operating condition of the first embodiment. The differences between the third embodiment and the first embodiment are that each of the machine functions S1, S2, S3, S4 and S5 which are comprised in the plurality of machine function group data G1 has a certain amount of machines, and that each of the products P1, P2 and P3 has objects which are waiting for being entered into production lines (the product P4 has no object to be entered into production line now).

More particularly, please refer to FIG. 3A first. As for the machine function group data G1, the machine function S1 comprises three machines m_{1,1}, m_{1,2} and m_{1,3} which are capable of performing an identical machine function, the machine function S2 comprises four machines m_{2,1}, m_{2,2}, m_{2,3} and m_{2,4} which are capable of performing an identical machine function, the machine function S3 comprises three machines m_{3,1}, m_{3,2} and m_{3,3} which are capable of performing an identical machine function, the machine function S4 comprises three machines m_{4,1} and m_{4,2} which are capable of performing an identical machine function, and the machine function S5 comprises three machines m_{5,1}, m_{5,2} and m_{5,3} which are capable of performing an identical machine function. It shall be noted that each of machine function comprises machines which are capable of executing similar machine function and may be a same brand or different brands. The performance differences between each of machines are within a tolerable level; therefore, the machines are replaceable with each other.

Each of the products P1, P2 and P3 comprises products which are waiting for being entered into production lines. The Product P1 comprises products n_{1,1}, n_{1,2} and n_{1,3}. The Product P2 comprises products n_{2,1} and n_{2,2}. The Product P3 comprises products n_{3,1} and n_{3,2}. The quantities of each of the products P1, P2 and P3 are merely used for explanation. Each of the products P1, P2 and P3 may has more quantity but not to limit the present invention. The production paths of products P1, P2 and P3 are based on a production line allocation data M3 (like the first production line allocation data M1 shown in FIG. 1C) which is determined by the production line automatically allocating device 1. The product P1 is allocated with the machines m_{1,1}, m_{2,1}, m_{3,1} and m_{5,1}. The product P2 is allocated with the machines m_{1,2}, m_{3,2} and m_{5,2}. The product P3 is allocated with the machines m_{1,3}, m_{2,2}, m_{4,1} and m_{5,3}. The dashed lines in the flow chart represents that a product is waiting for being processed or has not been processed yet.

Next, please refer to FIG. 3B. FIG. 3B illustrates the status of the production line allocation data M3 which is operated after a period, wherein the dashed lines in the flow chart represents that a product is waiting for being processed or has not been processed yet, and the solid lines in the flow chart represents a product is being processed or can be entered into the next stage. The production line automatically allocating device 1 is capable of continuously updating the production line allocation data M3 according to the plurality of machine status feedback data D3; therefore, the progress of each of the products on the production lines can be clearly observed.

For example, as for the product P1, the product n_{1,1} has been finished with the operations of the machine m_{1,1}, m_{2,1} and m_{3,1}, and is being entered into the machine m_{5,1}. The product n_{1,2} has been finished with the operations of the machine m_{1,1} and m_{2,1}, and is being entered into the machine m_{3,1}. The product n_{1,3} is being entered into the machine m_{1,1}. In other words, as for the same series of products, since each of machines continuously returns machine status feedback data, the production line automatically allocating device can arrange products into production lines at the right timing in order to reduce idling time of machines and increase the production efficiency.

Next, please refer to FIG. 3C. In one implementation, if a production line machine returns malfunction information to the production line automatically allocating device 1, the production line automatically allocating device 1 can label malfunction information for the broken-down machine and search for a substitute machine in order to keep processing products on production lines. Here is the case for example that the product n_{2,1} has been finished with the operations of the machine m_{1,2} and should be entered into the machine m_{3,2}, but the machine m_{3,2} occurs a malfunction before the product n_{2,1} is entered into the machine m_{3,2}. In this case, after the production line automatically allocating device 1 receives the machine status feedback data, the production line automatically allocating device 1 labels the machine m_{3,2} with unavailable status and allocates product m_{2,1} with the currently available machine m_{3,3} in order to keep products being processed smoothly.

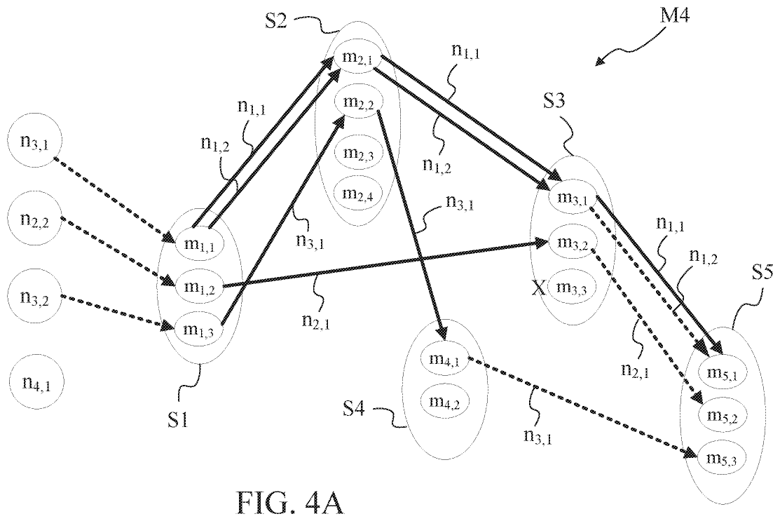

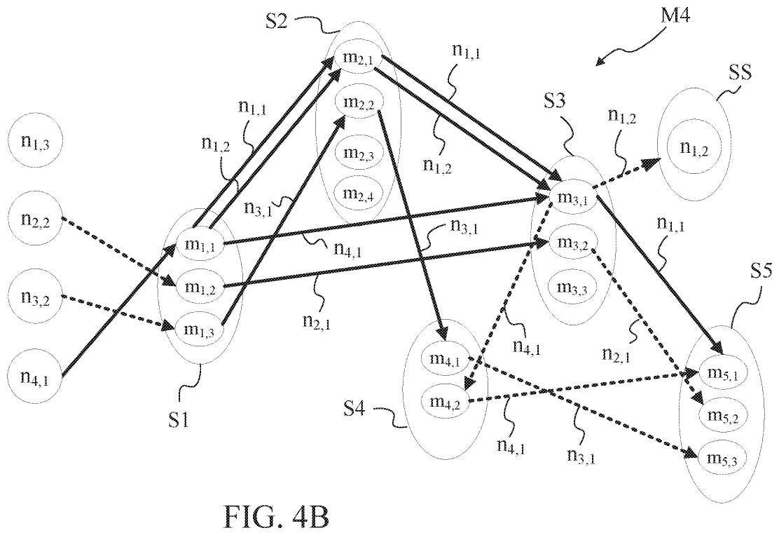

Please refer to FIGS. 4A and 4B for the fourth embodiment. The fourth embodiment is an extension of the third embodiment. The production line allocation data M4 of the fourth embodiment has the elements which are similar with the production line allocation data M3 of the third embodiment, and the elements with the same symbols can perform similar operations; therefore, the differences between the third embodiment and fourth embodiment are described only in the following.

Specifically, in the fourth embodiment, the production line automatically allocating device 1 receives an emergency order, and needs to arrange the product P4 which has high priority (e.g. the product n_{4,1}) into the production lines accordingly. At this moment, the product P4 may be considered to be a second fabrication process data. The production line automatically allocating device 1 further determines a second production line allocation data M4 and a suspended production data according to the first production line allocation data M3 and the second fabrication process data, wherein a priority of the second production line allocation data M4 is higher than a priority of the first production line allocation data M3.

Since the product P4 needs machines with the machine functions S1, S3, S4 and S5 and the machine m_{3,3} is in the unavailable status, the production line automatically allocating device 1 determines to allocate the machines m_{2,2}, m_{3,2}, m_{4,2} and m_{3,2} for the product n_{4,2} after evaluating. It shall be noted that the production line automatically allocating device 1 can determine the production line allocation data according to an optimization function, and the features of the production line automatically allocating device 1 can be referred from the aforesaid content of the first embodiment.

Since the production lines only comprise the limited number of machines, the production line automatically allocating device 1 needs to suspend the production of part of products P1. Specifically, since the product n_{1,3} has not been entered into production line, the product n_{1,3} is suspended. Although the product n_{1,2} is ready to be entered into the machine m_{3,1}, the product n_{4,1} has to be entered into the machine m_{3,1} immediately once the operation of the machine m_{1,1} is finished. Therefore, since the time condition cannot be matched, the product n_{1,2} is moved to a suspended group SS and the production line automatically allocating device 1 generates a suspended status production data in order to arrange product n_{1,2} back into production line at the proper timing. The product n_{1,1} is about to be entered into the machine m_{3,1} and the production line automatically allocating device 1 determines that the production schedule of the product n_{4,1} will not be affected; therefore, the product n_{1,1} will be entered into machine m_{3,1} as schedule.

In other words, in the fourth embodiment, when the production line automatically allocating device receive an emergency order information or any information which affects production line allocation (i.e. an order with different products), the production line automatically allocating device determine a new production line allocation data according to an optimization function. The production line automatically allocating device also transmits corresponding control commands to the corresponding fabrication process machines to make adjustment in order to reach the benefit expected in practice.

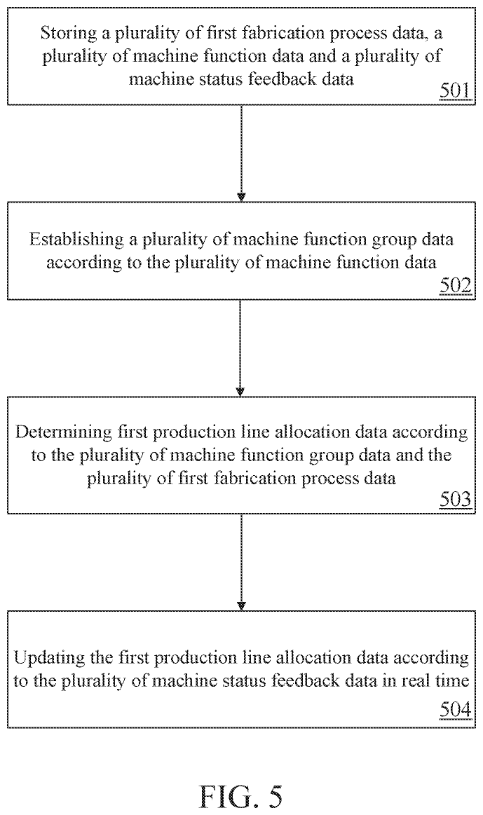

The fifth embodiment of the present invention is a production line automatically allocating method. Please refer to FIG. 5. The production line automatically allocating method is adapted for a production line automatically allocating device (i.e. the production line automatically allocating device 1 of the first embodiment) which comprises a storage and a processor.

First, in the step 501, the storage stores a plurality of first fabrication process data, a plurality of machine function data and a plurality of machine status feedback data. In the step 502, the processor establishes a plurality of machine function group data according to the plurality of machine function data. In the step 503, the processor determines first production line allocation data according to the plurality of machine function group data and the plurality of first fabrication process data. In the step 504, the processor updates the first production line allocation data according to the plurality of machine status feedback data in real time.

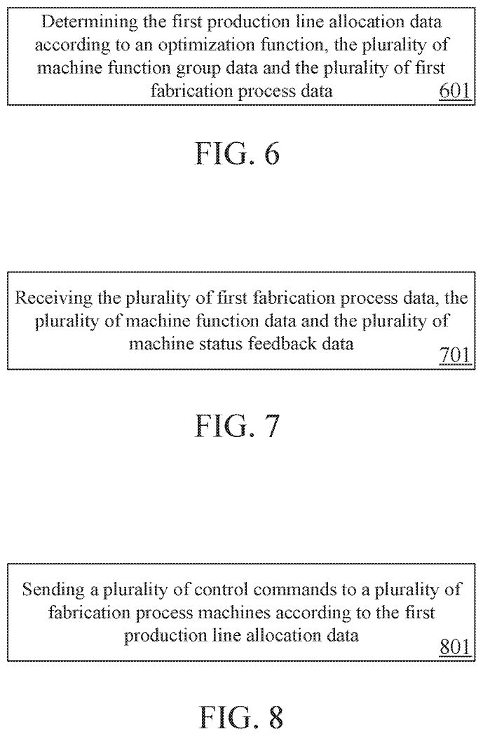

The sixth embodiment of the present invention is a production line automatically allocating method. Please refer to FIG. 6. Specifically, the sixth embodiment is an extension of the fifth embodiment. In the sixth embodiment, the storage stores an optimization function, and the processor determines the first production line allocation data according to the optimization function, the plurality of machine function group data and the plurality of first fabrication process data. The optimization function is a profit function, a cost function, a time function, etc. People skilled in this field understand optimization functions and can design the optimization functions accordingly, and select the proper function according to the real demands.

The seventh embodiment is a production line automatically allocating method. Please refer to FIG. 7. Specifically, the seventh embodiment is an extension of the fifth embodiment. In the seventh embodiment, the production line automatically allocating device further comprises a transceiver. The production line automatically allocating method further comprises the following step of: the processor receives the plurality of first fabrication process data, the plurality of machine function data and the plurality of machine status feedback data via the transceiver.

The eighth embodiment is a production line automatically allocating method. Please refer to FIG. 8. Specifically, the eighth embodiment is an extension of the fifth embodiment. In the eighth embodiment, the production line automatically allocating device further comprises a transceiver. The production line automatically allocating method further comprises the following step of: the processor sends a plurality of control commands to a plurality of fabrication process machines according to the first production line allocation data.

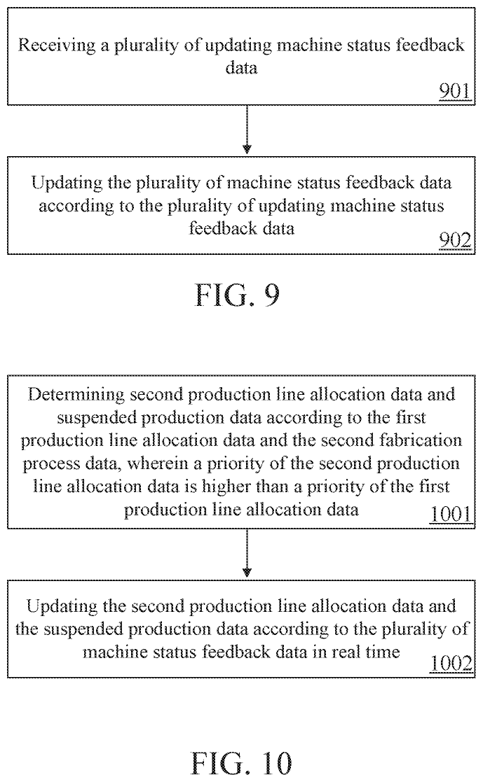

The ninth embodiment is a production line automatically allocating method. Please refer to FIG. 9. Specifically, the ninth embodiment is an extension of the fifth embodiment. In the ninth embodiment, the production line automatically allocating device further comprises a transceiver. The production line automatically allocating method further comprises the following steps of: the transceiver is configured to receive a plurality of updating machine status feedback data; and the processor is further configured to update the plurality of machine status feedback data according to the plurality of updating machine status feedback data.

The tenth embodiment is a production line automatically allocating method. Please refer to FIG. 10. Specifically, the tenth embodiment is an extension of the fifth embodiment. In the tenth embodiment, the storage is further configured to store second fabrication process data. The production line automatically allocating method further comprises the following steps of: the processor is further configured to determine second production line allocation data and suspended production data according to the first production line allocation data and the second fabrication process data, wherein a priority of the second production line allocation data is higher than a priority of the first production line allocation data, and the processor is further configured to update the second production line allocation data and the suspended production data according to the plurality of machine status feedback data in real time.

In addition to the aforesaid fifth embodiment to the tenth embodiment, the production line automatically allocating method of the present invention is capable of performing all of the same functions mentioned in the aforesaid first embodiment to the fourth embodiment of the present invention, and delivers the same technical effects. Thus, the similar details are omitted. Besides, in the condition that the features do not conflict with each other, the aforesaid embodiments and implementations can be combined as an embodiment.

In summary, the production line automatically allocating device and production line automatically allocating method of the present invention determine production line allocation data according to each of products and each of machines, and continuously receive feedback message to adjust the production line allocation data accordingly; thus, the present invention effectively decreases the idling time of production line machines, decreases conflicts between production line machines, and increases the efficiency of production line. Therefore, in comparison with tracking and adjusting which are performed by manpower in the art, the production line automatically allocating device and the production line automatically allocating method of the present invention effectively improve the efficiency of production lines.

The above disclosure is related to the detailed technical contents and inventive features thereof. People of ordinary skill in the art may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A production line automatically allocating device, comprising:
a storage, configured to store a plurality of first fabrication process data, a plurality of machine function data and a plurality of machine status feedback data; and
a processor, electrically connected to the storage and configured to:
establish a plurality of machine function group data according to the plurality of machine function data;
determine first production line allocation data according to the plurality of machine function group data and the plurality of first fabrication process data; and
update the first production line allocation data according to the plurality of machine status feedback data in real time.

2. The production line automatically allocating device of claim 1, wherein:
the storage is further configured to store an optimization function; and
the processor is further configured to determine the first production line allocation data according to the optimization function, the plurality of machine function group data and the plurality of first fabrication process data.

3. The production line automatically allocating device of claim 1, further comprising a transceiver, wherein the processor receives the plurality of first fabrication process data, the plurality of machine function data and the plurality of machine status feedback data via the transceiver.

4. The production line automatically allocating device of claim 1, wherein the processor further sends a plurality of control commands to a plurality of fabrication process machines according to the first production line allocation data.

5. The production line automatically allocating device of claim 1, further comprising a transceiver which is configured to receive a plurality of updating machine status feedback data, wherein the processor further updates the plurality of machine status feedback data according to the plurality of updating machine status feedback data.

6. The production line automatically allocating device of claim 1, wherein:
the storage further stores a second fabrication process data;
the processor is further configured to determine second production line allocation data and suspended production data according to the first production line allocation data and the second fabrication process data, wherein a priority of the second production line allocation data is higher than a priority of the first production line allocation data; and
the processor is further configured to update the second production line allocation data and suspended production data according to the plurality of machine status feedback data in real time.

7. A production line automatically allocating method, being adapted for a production line automatically allocating device which comprises a processor and a storage, the production line automatically allocating method comprising:
storing, by the storage, a plurality of first fabrication process data, a plurality of machine function data and a plurality of machine status feedback data;
establishing, by the processor, a plurality of machine function group data according to the plurality of machine function data;
determining, by the processor, first production line allocation data according to the plurality of machine function group data and the plurality of first fabrication process data; and
updating, by the processor, the first production line allocation data according to the plurality of machine status feedback data in real time.

8. The production line automatically allocating method of claim 7, wherein the storage further stores an optimization function, and the production line automatically allocating method further comprising:
determining, by the processor, the first production line allocation data according to the optimization function, the plurality of machine function group data and the plurality of first fabrication process data.

9. The production line automatically allocating method of claim 7, wherein the production line automatically allocating device further comprises a transceiver, and the production line automatically allocating method further comprising:
receiving, by the processor, the plurality of first fabrication process data, the plurality of machine function data and the plurality of machine status feedback data via the transceiver.

10. The production line automatically allocating method of claim 7, further comprising sending, by the processor, a plurality of control commands to a plurality of fabrication process machines according to the first production line allocation data.

11. The production line automatically allocating method of claim 7, wherein the production line automatically allocating device further comprises a transceiver, and the production line automatically allocating method further comprising:
receiving, by the transceiver, a plurality of updating machine status feedback data; and
updating, by the processor, the plurality of machine status feedback data according to the plurality of updating machine status feedback data.

12. The production line automatically allocating method of claim 7, wherein the storage further stores second fabrication process data, and the production line automatically allocating method further comprising:
determining, by the processor, second production line allocation data and suspended production data according to the first production line allocation data and the second fabrication process data, wherein a priority of the second production line allocation data is higher than a priority of the first production line allocation data; and
updating, by the processor, the second production line allocation data and the suspended production data according to the plurality of machine status feedback data in real time.
